(19) United States
(12) Patent Application Publication
(10) Pub. No.: US 2026/0089130 A1
(43) Pub. Date: Mar. 26, 2026

(54) SYSTEMS AND METHODS FOR GENERATIVE AI-BASED ELECTRONIC MAIL TOOL MANAGEMENT

(71) Applicant: YAHOO ASSETS LLC, New York, NY (US)

(72) Inventors: Sanika SHIRWADKAR, Milpitas, CA (US); Yitong WANG, South Plainfield, NJ (US); Kenneth SEBASTIAN, Danville, CA (US); Rofaida ABDELAAL, Sunnyvale, CA (US); Bhopal SINGH, San Jose, CA (US)

(21) Appl. No.: 18/897,018

(22) Filed: Sep. 26, 2024

(51) Int. Cl. H04L 51/214; G06F 16/34; G06Q 10/107

(52) U.S. Cl. CPC H04L 51/214; G06F 16/345; G06Q 10/107

(57) ABSTRACT

Disclosed are systems and methods that provide a scalable, decision intelligence (DI)-based computerized framework for verifying accuracy and consistency of provided functionality within an electronic mail platform. Hallucinations in AI-generated email summaries and quick action suggestions can undermine accuracy and trust, making it essential to implement strategies for their detection and mitigation. The disclosed framework operates by ensuring AI models are trained on high-quality, diverse datasets is crucial in minimizing the occurrence of hallucinations. Using attention mechanism and verification techniques, the framework can help focus the model's analysis on relevant sections of the email, thereby leading to continual updates and fine-tuning of models that can enhance the AI's reliability. By combining computerized oversight, robust training, and post-generation checks, the framework can operate to address hallucinations in email processing by mitigating their presence to ensure more accurate and actionable outputs.

### FIELD OF THE DISCLOSURE

The present disclosure relates to electronic messaging verification and control, and more particularly, to a scalable, decision intelligence (DI)-based computerized framework for verifying accuracy and consistency of provided functionality within an electronic mail platform.

### SUMMARY OF THE DISCLOSURE

Delivering electronic messages (“emails”) to inboxes in modified manners, such as with summaries, quick actions, or classifications, can vastly improve the efficiency and usability of email or messaging systems for recipients. Such approaches streamline communication and allows users to prioritize, interact with, and respond to messages more effectively. As the volume of emails and other digital messages continues to rise, finding new methods to reduce information overload and enhance productivity has become crucial. Several modifications to traditional email delivery can support these goals, including features like automated summaries, quick actions, and message classification. Such innovations, when combined, provide a cohesive system that empowers users to process and manage their messages in a more streamlined and effective manner.

One of the most significant improvements to modern email systems is the use of automated summaries. With the growing number of emails that many professionals receive daily, the need for concise overviews is essential. Summaries, often referred to as “TLDR” (Too Long; Didn't Read), distill long or complex emails into brief points that highlight the most important information. This allows the recipient to grasp the key message without needing to read through the entire text. For example, an email service and/or application can offer the capability to generate automated summaries using artificial intelligence (AI), machine learning (ML) and/or large language models (LLMs)—for example, natural language processing (NLP) algorithms.

In some embodiments, a summarization tool can be used. Such tools can identify important keywords, extract relevant sentences, and condense the information into a few bullet points or sentences, which can be displayed as message items within an inbox of a recipient, thereby enabling the recipient user to view the summary without opening the message item for the corresponding electronic message.

Additionally, quick actions are a powerful feature that allows users to interact with emails and messages directly from their inbox without opening the entire message. Quick actions provide users with buttons or links that can be clicked to perform specific tasks, such as approving a request, scheduling a meeting, or archiving a message. This enables users to act on essential messages quickly, eliminating the need to navigate through multiple emails or applications to complete a task. For example, an email containing a meeting invitation might include a quick action that lets the user respond with “Accept” or “Decline” right from the inbox preview. Similarly, a payment request could feature a “Pay Now” button that leads directly to a payment gateway.

According to some embodiments, by way of a non-limiting example, a quick action model may be used. Quick actions transform the inbox from a passive receptacle of information into an interactive hub where recipients can take immediate steps on relevant tasks. This not only saves time but also reduces the cognitive load of having to remember and revisit each task later.

Accordingly, AI-powered insights provide mechanisms for electronic messages to be delivered in a more streamlined manner. Modern email clients and messaging platforms increasingly leverage AI to offer intelligent suggestions based on the content of the email. For example, AI can recommend quick replies, suggest meeting times, or even predict the next steps in an email chain. This helps to speed up the process of responding to routine emails by providing contextually relevant options for the user. Similarly, AI can identify key dates, tasks, or follow-ups mentioned in the email and offer to add them to the user's calendar or task management system automatically. This prevents important items from falling through the cracks while saving the user time in manually managing their schedule or to-do list.

Modifying the delivery of electronic messages through the use of summaries, quick actions, classifications, digests, AI-powered insights, and other enhancements can create a more streamlined experience for users. These features allow recipients to prioritize messages, respond quickly to actionable items, and avoid being overwhelmed by the sheer volume of incoming communications.

However, there are safeguards that need to be put in place, but in general, in layman's terms, AI outputs need to be verified. For example, hallucinations, in the context of AI and LLMs, refer to instances when an AI system generates information or content that does not accurately reflect the original input data. When applied to generating summaries or quick actions in electronic messages, hallucinations can be problematic. These issues arise when the AI produces text or suggestions that either distort, omit, or misinterpret the content of the original message. Hallucinations can significantly impact the effectiveness of summaries and quick actions, as they may lead to inaccuracies or incomplete representations of important information. Such discrepancies between the summaries or quick actions and the actual content of the message can undermine the value of these tools and even create critical flaws in how users engage with their inboxes.

AI-generated summaries aim to condense a large volume of information into a brief, digestible format. Ideally, this allows users to quickly grasp the key points of an email without having to read the entire message. However, if the AI hallucinates and generates a summary that does not accurately reflect the original content, the user may be misled or may fail to act on important information.

For example, an AI system tasked with summarizing a business proposal might misinterpret or hallucinate details about key terms, such as pricing, deadlines, or responsibilities. If the summary omits an important deadline or provides incorrect information about a contract, it can lead to missed opportunities or misunderstandings between the sender and recipient. Hallucinations may occur when the AI misinterprets ambiguous language, focuses on irrelevant details, or attempts to “fill in gaps” where information is unclear. The risk of miscommunication is particularly high in professional or legal contexts where precise language is crucial.

Moreover, if the user relies solely on the summary without cross-referencing the original email, these hallucinations can compound over time, leading to systemic issues in decision-making. For instance, in a corporate environment, if key stakeholders base their decisions on inaccurate summaries, the entire decision-making process could be flawed. This potential for generating misleading or erroneous information is one of the biggest challenges in using AI to automate tasks like summarization.

Quick actions, such as buttons for approving requests, scheduling meetings, or marking tasks as complete, also depend heavily on the AI's accurate interpretation of the original message's content. Hallucinations in this context can lead to inappropriate or misleading quick actions, which in turn could result in unintended consequences.

For example, if an email contains a discussion about scheduling a meeting, but the AI incorrectly interprets the conversation as a finalized agreement on a time and date, it might generate a quick action to “Confirm Meeting” when no actual meeting has been agreed upon. Similarly, if an AI-generated quick action suggests approving an invoice or making a payment based on incomplete or inaccurate information from the email, the user could take unintended actions that have financial or operational repercussions. In both cases, the AI has essentially created a false narrative based on incomplete understanding, and users who trust the quick actions without verifying the details may end up making critical mistakes.

The disconnect between AI-generated summaries or quick actions and the actual content of the message can introduce several critical flaws. First and foremost, it damages trust in the system. Users rely on these tools to save time and effort, but if the generated summaries or quick actions are frequently inaccurate, users may stop relying on them altogether. This defeats the purpose of having AI-driven enhancements, as the system becomes unreliable and counterproductive.

Furthermore, inaccuracies can result in miscommunication, which is especially problematic in professional, financial, or legal environments. If, for example, a summary omits or alters a crucial term in a legal contract email, the recipient may act based on incomplete information, leading to breaches of agreement or unintentional non-compliance. In financial transactions, any inaccuracies in summaries or quick actions—such as approving a payment based on an incorrectly summarized invoice—can lead to serious financial losses. These types of errors undermine the efficiency and reliability that AI-driven systems are supposed to provide.

In some cases, inaccuracies can lead to unintended actions. For example, an AI might generate a quick action to “Accept Terms” for a contract when the user has yet to fully review the details, leading to agreements being made without proper scrutiny. This can have legal ramifications, as decisions made based on inaccurate summaries or quick actions may be binding even if they were made in error. This may introduce a flaw in the system's utility: it promises convenience but can instead create costly mistakes when information is not accurately presented or understood.

To that end, the disclosed systems and methods operate to prevent AI-related hallucinations and/or mitigate their impact. That is, preventing hallucinations in AI-generated summaries and quick actions requires careful design and robust safeguards. One approach is to ensure that AI systems are trained on diverse, high-quality datasets to minimize the likelihood of hallucinations and improve their ability to accurately summarize and interpret emails. Developers must continuously refine these systems by focusing on context-aware AI/ML and/or LLM models that can better understand the intricacies of human language, such as ambiguous phrasing or nuanced terms.

Accordingly, as discussed herein, incorporation of computerized verification steps before deployed developed summaries and/or quick actions can ensure what is provided to the end-user is what the system intended. For example, after generating a quick action to “Approve” an invoice, the system could perform an audit to verify that the quick action corresponds with the original content before committing to a potentially irreversible action. Moreover, feedback loops can be incorporated therein, which can identify, report and/or correct hallucinations when they occur. By learning from audit trails and outputs, AI models can become more reliable over time, reducing the frequency of hallucinations and increasing the accuracy of future outputs.

Thus, while AI-driven features like summaries and quick actions have the potential to greatly streamline electronic communication, hallucinations pose a significant risk to their reliability. Inaccuracies between the AI-generated outputs and the original message can lead to miscommunication, loss of trust, and even unintended actions with serious consequences. Therefore, the disclosed systems and methods provide a computerized framework to audit and confirm the accuracy of such outputs prior to the deployment to ensure these systems remain useful and trustworthy for users.

According to some embodiments, a method is disclosed for a DI-based computerized framework for verifying accuracy and consistency of provided functionality within an electronic mail platform. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for verifying accuracy and consistency of provided functionality within an electronic mail platform.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

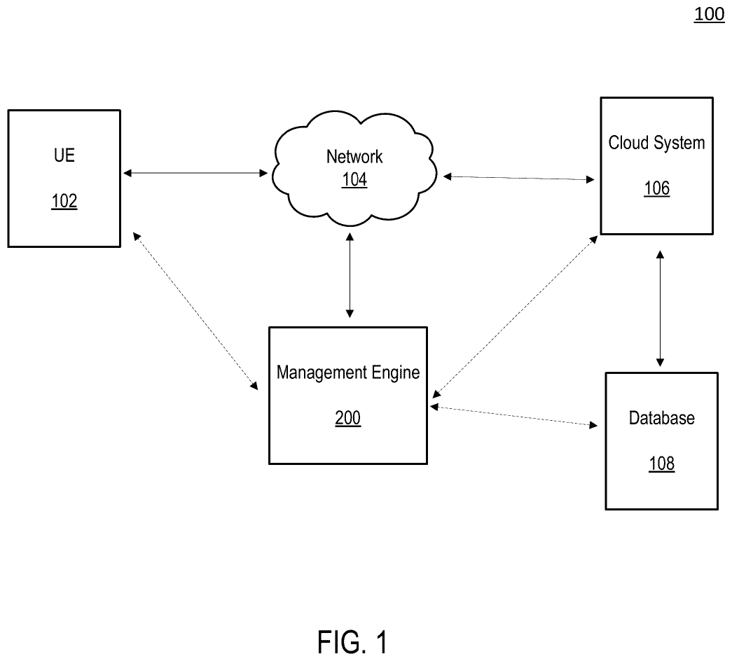

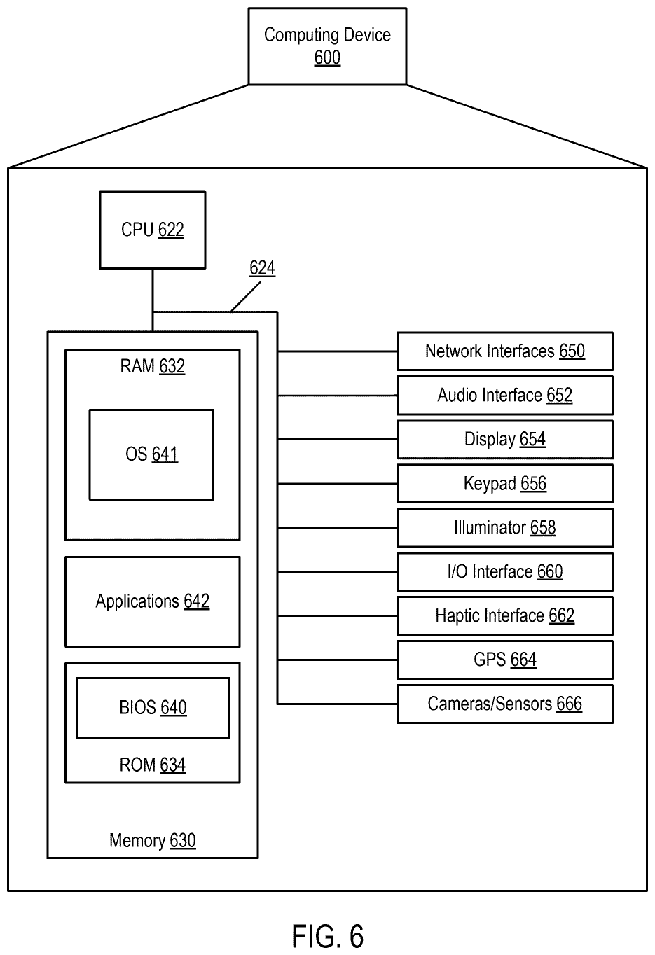

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and management engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network and/or electronic mail platform (e.g., Yahoo! Mail®, for example), which has associated network resources hosted on the internet or private network (e.g., network 104), which enables (via engine 200) the tagging and search functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

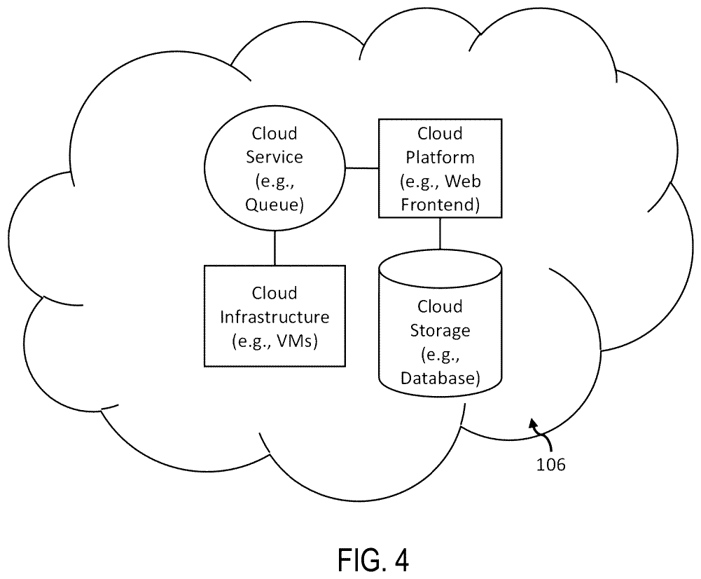

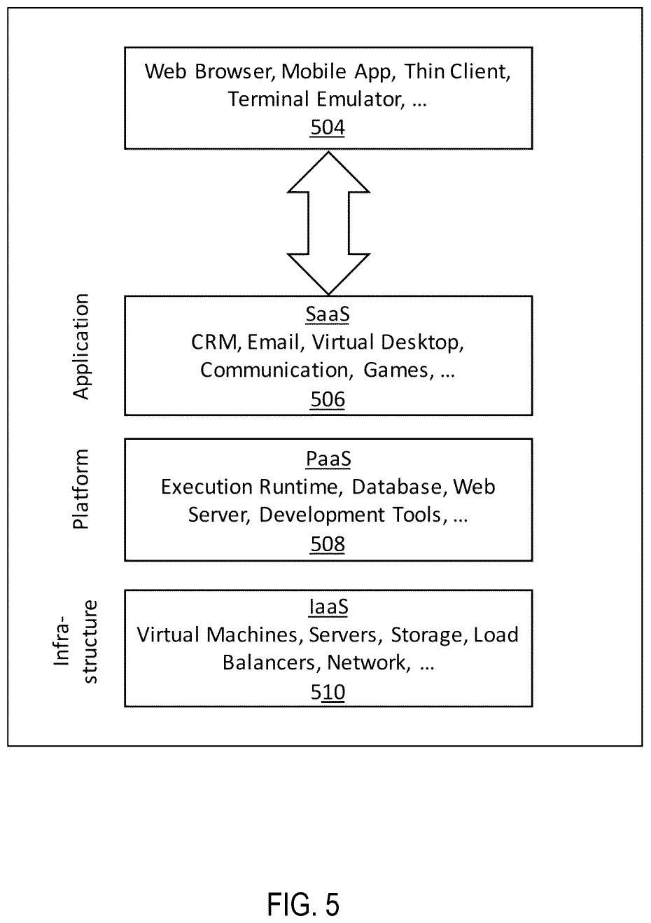

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Management engine 200, as discussed above and further below in more detail, can include components for the disclosed functionality. According to some embodiments, management engine 200 may be a special purpose machine or processor, and can be hosted by a device on network 104, within cloud system 106, and/or on UE 102. In some embodiments, engine 200 may be hosted by a server and/or set of servers associated with cloud system 106.

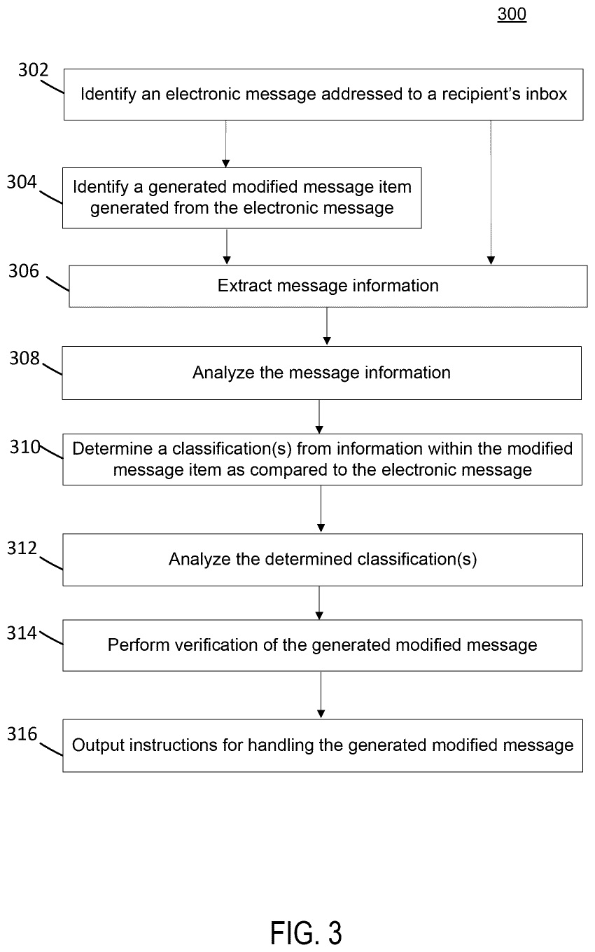

According to some embodiments, as discussed in more detail below, management engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below in relation to at least FIG. 3.

According to some embodiments, as discussed above, management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

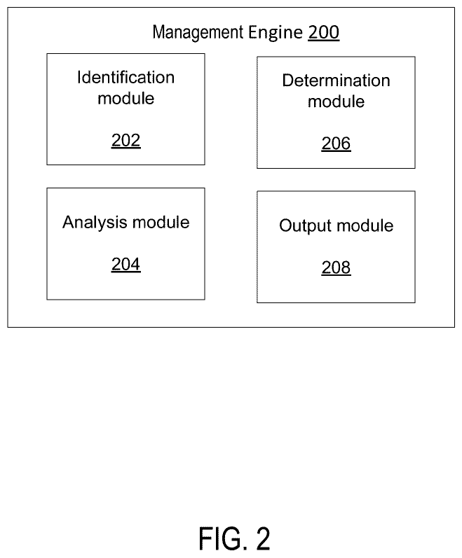

As illustrated in FIG. 2, according to some embodiments, management engine 200 includes identification module 202, analysis module 204, determination module 206 and output module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below. Management engine 200 or other device(s) running Process 300 may be operated entirely at the user device level, or with cloud support as a distributed system, or at a mail service provider's infrastructure, as non-limiting implementation examples. It will be understood that the disclosure herein provides for a configuration that is platform agnostic and may be operated on multiple alternative platforms as a matter of design choice using the teachings described.

Turning to FIG. 3, Process 300 provides non-limiting example embodiments for determining and implementing mechanisms for verifying and/or mitigating occurrences of inaccuracies between generated message items and originally communicated electronic messages. As provided below, the disclosed framework's configuration and implementation can provide a computerized suite of tools for providing advancements in how electronic messages are handled pursuant to their display within a recipient's inbox, as well as how users can interact with such electronic messages.

According to some embodiments, Steps 302-306 of Process 300 can be performed by identification module 202 of management engine 200; Steps 308 and 312 can be performed by analysis module 204; Steps 310 and 314 can be performed by determination module 206; and Step 316 can be performed by output module 208.

According to some embodiments, Process 300 begins with Step 302 where an electronic message addressed to an inbox of a user is identified. As discussed above, engine 200 can operate on a UE (e.g., sender and/or recipient device) and/or on a device on the network; therefore, in some embodiments, the identification of the message can be performed upon receiving the message at the relaying server (e.g., message server on network 104), and/or at the recipient device (e.g., via engine 200 acting in accordance with an email client running on a recipient user's UE).

Thus, as discussed herein, the disclosed operational steps of Process 300 can be performed at the cloud/network level, and/or at the user device level, without the need for cloud communication, as devices are now and in the future capable of running artificial intelligence (AI) applications in whole or in part without the need for cloud support.

In Step 304, engine 200 can identify (and/or operate to generate) a modified message item, which is generated from the electronic message (identified in Step 302).

As discussed above, messages (from Step 302) can be subject to analysis by an LLM model, for which action steps can be performed by a called action/triaging model. In some embodiments, the triaging model can be a summarization model, quick actions model, and the like.

For example, a message summarization model can be an LLM which can perform operations to generate an NLP summary of the content associated with the electronic message. In some embodiments, the summary may be constricted to a number of characters proportional to an amount of space available within a message inbox item that is capable of being displayed within an inbox of a user's messaging account display page.

According to some embodiments, by way of a non-limiting example, engine 200 can call a message summarization model.

In another example, a quick actions model can be an LLM model that can analyze the message (and/or message information), and determine which quick actions to perform on the message and/or display in connection with the message. For example, add to calendar, view attachment, forward, reply, trash, and the like, all from the message item displayed in the inbox without having to open the message.

According to some embodiments, by way of a non-limiting example, engine 200 can call a quick action model.

Thus, as discussed above, engine 200 can execute such model(s) to perform steps for generation of a summary, a curated/customized title of the email and/or provide actions for the user to perform on a message (e.g., add to calendar, respond, delete, forward, and the like), as discussed in the above referenced US patent applications, inter alia.

In Step 306, engine 200 can operate to extract message information, which can be extracted from the electronic message (from Step 302) and from the message item (from Step 304).

In some embodiments, engine 200 can the message information, for the electronic message and/or the message item, can include information related to, but not limited to, a message type, sender identifier (ID), recipient ID, content, content type, token count, category, character count, structure/format of the message (e.g., document object model (DOM) or template), age-appropriateness of the content (e.g., PG-13), a time, date, location of the recipient, and the like, or some combination thereof.

Accordingly, in some embodiments, Step 306 can involve engine 200 parsing the electronic message, which can correspond to a type of criteria (which can correspond to any of the data/metadata types indicated above, for example) to extract certain types of information. Similar steps can be performed for the message item. In some embodiments, all extractable information can be identified/extracted in Step 306, and in some embodiments, a portion or subset of the information can be utilized.

In some embodiments, such information may be extracted upon the reception of the message (in Step 302) and/or upon generation of the message item (in Step 304); therefore, the message information for the electronic message and the message information for the message item can be retrieved from storage (e.g., database 108, as discussed above).

In Step 308, engine 200 can analyze the extracted message information from the electronic message and the message item. According to some embodiments, the computational analysis performed in Step 308 can involve engine 200 calling and executing an AI, ML and/or LLM that operates to classify (and/or filter) electronic/digital communications, such as emails. In some embodiments, as discussed herein, when applied to classifying mail messages, the classification model(s) (and/or ensemble) can analyze the extract message information (from the electronic message, inclusive of the content and metadata associated therewith), to, inter alia, determine how to classify a message and perform filtering steps based on certain types of data, as discussed infra in relation to Step 310.

Accordingly, in some embodiments, the AI/ML models can be any type of known or to be known, specifically trained AI/ML model, particular machine learning model architecture, particular machine learning model type (e.g., convolutional neural network (CNN), recurrent neural network (RNN), autoencoder, support vector machine (SVM), and the like), or any other suitable definition of an AI/ML model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, the message triaging model may be configured to identify and utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Accordingly, based on the AI/ML and/or LLM based analysis in Step 308, engine 200 can determine a set of classifications (e.g., a classification or plurality of classifications) from the information extracted from the modified message item as compared to the electronic message. In general, engine 200 can determine if the message item (from Step 304) accurately represents (e.g., to a threshold degree of similarity) the electronic message (from Step 302) (e.g., is the content and/or context represented in the message item). For example, engine 200 can determine whether a generated summary accurately represents the context and key aspects of the content of the electronic message. In another non-limiting example, engine 200 can perform a classification as to whether a provided quick action maps to a requested task/feedback from the electronic message.

According to some embodiments, as discussed herein, Step 310's determination (and subsequent processing Steps 312-316) provides a structured process for post-processing and validating and/or verifying generated content, particularly when working with AI models in the context of summarizing or extracting actionable insights from emails.

According to some embodiments, engine 200 can operate to ensure adherence to a predefined JavaScript Object Notation (JSON) schema. In some embodiments, engine 200 can validate that the generated content of the message item follows a predefined JSON schema. Such schema defines the structure that the output must adhere to, and it includes key attributes such as ‘summary’, ‘email_title’, and ‘actionable_next_steps’. The schema acts as a contract between the system generating the output and the downstream systems that will process or consume it.

JSON is a lightweight data-interchange format that is easy to read and write for both humans and machines. By enforcing this schema, engine 200 can ensure that essential data points are present and correctly structured in the message item. It also helps prevent formatting errors, such as missing fields or invalid data types, which could disrupt subsequent workflows. This is crucial in automated systems, as downstream processes often rely on the predictability and consistency of the data structure to function properly.

For example, if the JSON schema requires a “summary” field, the absence of this field would signal that the content generation process failed or that the output is incomplete. By catching this at the post-processing stage, issues can be corrected before the content is further processed or delivered to users.

According to some embodiments, engine 200 can operate to apply threshold-based filters for length and/or word Count. In some embodiments, after validating the format, engine 200 can apply threshold-based filters to check the length and/or word count of the generated content. These filters ensure that the output falls within an acceptable range of word count and length. For example, if the content is too short, it might suggest that the summary is inadequate or that the system missed extracting key points. Conversely, if the content is excessively long (e.g., beyond a character limit), it could indicate redundancy or an overly verbose generation that might dilute the actionable insights.

By setting both lower and upper thresholds, engine 200 can maintain a balance, ensuring the content is concise enough to be practical but sufficiently detailed to convey important information. The ideal length for a summary, title, or actionable steps may vary depending on the use case, but setting thresholds ensures that outputs meet user expectations and business needs.

According to some embodiments, engine 200 can perform operations to flag invalid and/or repeating text patterns. Repetitive or nonsensical text patterns are common issues in content generated by AI models. For example, a model might repeat phrases or sentences if it fails to generate diverse, meaningful content from the input. Engine 200 can operate to identify and flag these patterns as part of the post-processing checks.

Moreover, such checks help improve the quality of the output by ensuring that the generated content is both coherent and informative. Such checks also help in detecting when a model might be hallucinating, as discussed above. By flagging and potentially removing these patterns, the post-processing ensures that the content maintains a high level of factuality and relevance.

According to some embodiments, engine 200 can perform operations to employ name entity recognition (NER) for factual alignment. NER is a natural language processing (NLP) technique that identifies and classifies proper nouns and other significant entities in the text, such as people, organizations, dates, locations, and more. By employing NER in the post-processing stage, engine 200 can cross-reference the entities in the generated content with those in the original email. Indeed, this ensures that important entities like names, companies, dates, and locations are factually aligned and consistent. If engine 200 detects discrepancies between the entities in the original email and the generated content, it can flag or correct these issues, preventing the propagation of false or misleading information. For example, if the original email mentions “Acme Corp” as the sender, but the generated summary refers to “Tech Innovations Ltd. ”, the system can flag this discrepancy for further review or correction. This step is essential for maintaining the factual integrity of the output.

According to some embodiments, engine 200 can perform operations to verify uniform resource locators (URLs). In many cases, emails contain URLs that point to important resources, such as documents, websites, or other actionable links. To prevent the generation of incorrect or fabricated URLs, engine 200 can cross-references any URLs in the generated content with the URLs found in the original email. This is a critical step because incorrect URLs can lead to security risks, such as phishing attempts or malicious websites. It also ensures that the output remains relevant and trustworthy. If the generated content includes URLs that were not present in the original email, the system will flag them for review or remove them entirely. For example, if the original email includes a link to “https://example.com” and the generated output contains “https://wrongurl.com”, the system will identify this mismatch and take corrective action, ensuring that users are only directed to valid and intended destinations.

According to some embodiments, engine 200 can perform operations to check pronouns for consistency in narrative “voice.” Consistency in narrative voice is important for maintaining clarity and coherence in the generated content. Emails are often written in the first person, with the sender using pronouns like “I” or “we” to refer to themselves. Accordingly, engine 200 can check for the presence of first-person pronouns to ensure that the narrative voice in the generated content matches that of the original email. This is especially important when summarizing or paraphrasing content, as switching from first person to third person (e.g., “I sent the report” to “The report was sent”) can alter the tone and meaning. By verifying the use of first-person pronouns, engine 200 helps preserve the original intent and context of the email, making the output more accurate and easier for the recipient to understand.

According to some embodiments, engine 200 can perform operations to ensure an overlap of capitalized words and numbers. Capitalized words and numbers often represent important details in emails, such as names, dates, locations, and specific terminologies. Thus, engine 200 can check for a high overlap of capitalized words and numbers between the original email and the generated content. Such operation can ensure that key pieces of information, such as company names, project titles, important dates, and the like, are preserved accurately in the output. In some embodiments, engine 200 can account for different formats of numbers and dates, ensuring that variations (e.g., “October 5, 2023” vs. “05/10/2023”) are correctly handled and that the essential information remains intact.

According to some embodiments, engine 200 can perform operations to ensure accuracy of alphanumeric codes. Similar to the operations for capitalized words, engine 200 can check for alphanumeric codes (such as, for example, verification codes, order numbers, reference IDs and the like) in the output. Such codes are often critical for users, as they may need them for actions like logging into accounts, tracking orders, or verifying identities. Accordingly, engine 200 can ensure that the alphanumeric codes in the original email match those in the generated content. Given the importance of these codes, even minor inaccuracies (such as an extra digit or an incorrect character) can lead to significant problems, such as failed logins or inability to track a shipment. Thus, by ensuring a high overlap for these codes, engine 200's operations can function to ensure that the user receives the correct information needed for completing their tasks.

According to some embodiments, engine 200 can perform operations to check token overlap and cosine similarity for consistency. In some embodiments, token overlap and cosine similarity are techniques used to measure the similarity between the original email and the generated content. Token overlap measures the percentage of words (tokens) in the generated content that are also present in the original email. Cosine similarity, on the other hand, measures the semantic similarity between two pieces of text by comparing the angle between their vector representations in a multidimensional space. Such metrics provide additional data points for verifying the consistency and accuracy of the output. A high token overlap suggests that the generated content is closely aligned with the original text, while a high cosine similarity indicates that the overall meaning and context of the content are preserved.

Accordingly, by using such techniques, either alone or in combination, engine 200 can detect when the generated content diverges too much from the original email, either in terms of word choice or meaning. This ensures that the final output remains faithful to the source material.

According to some embodiments, engine 200 can perform operations to verify action locations and dates. In some embodiments, engine 200 can check for the presence of action locations and dates in the original email and ensures that these are correctly represented in the generated content. This includes handling different formats and variations, such as “Monday, March 3” vs. “03/03” for dates, or “Head Office” vs. “HQ” for locations. Such processing can ensure that critical information about when and where an action needs to take place is not lost or misrepresented in the summary or actionable next steps. For example, if the original email states: “The meeting will take place on March 3 at the HQ”, but the generated content omits the date or location, engine 200 can flag this omission for correction.

Accordingly, the processing in Steps 308-310 can involve a series of post-processing checks that are designed to ensure that the generated content remains consistent, accurate and useful. By adhering to a predefined structure, applying filters, and verifying factual details such as URLs, dates, entities, and alphanumeric codes, for example, engine 200 can maintain a high level of quality in the output. Each operation discussed above (e.g., each classification, which can be performed individually and/or in combination with each other, in some embodiments) contributes to a more reliable and user-friendly AI-generated output, improving both the user experience and the practicality of the system in real-world applications.

Continuing with Process 300, in Step 312 such determinations/classifications can be analyzed by engine 200 implementing any of the above mentioned AI/ML and/or LLM techniques, for which, in Step 314, engine 200 can determine or perform verification of the generated modified message. In some embodiments, engine 200 can perform Step 312's analysis by performing the classifications discussed above in relation to Step 310. Thus, in Step 314, engine 200 can determine if the message item (in Step 304) accurately maps (e.g., to a threshold level, as discussed above in Step 310) to the electronic message (in Step 302).

And, in Step 316, engine 200 can output instructions for handling the generated modified message (from Step 304). That at, for example, at the conclusion of Steps 302 and 304, the electronic message and/or message item may not be delivered to the inbox (or displayed for consumption by the recipient); therefore, upon verification indicating a threshold satisfying accuracy of the message item to the electronic message, engine 200 can cause delivery of the message item and/or electronic message. In contrast, if verification is not satisfied (e.g., the threshold value(s) are not met, as discussed above), then engine 200 can cause operation of Step 304's models, discussed supra, to regenerate the message item, for which the subsequent steps of Process 300 can be re-performed. In some embodiments, upon verification failing, engine 20 can alternatively or additionally cause the electronic message to be displayed, for which a message item can then be displayed upon it being verified in Step 314 (e.g., update the display of the message with the approved message item).

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying a message item, the message item being a modified message item associated with an electronic message addressed to an inbox of a recipient;
extracting message information, the extracted message information corresponding to the message item and the electronic message;
analyzing, via a computer model, the extracted message information;
determining, based on the computer model analysis, a set of classifications that provide indications of a manner the message item maps to the electronic message;
determining, based on the set of classifications, a verification of the message item; and
controlling delivery of the message item to the inbox based on the verification determination.

2. The method of claim 1, further comprising:
analyzing the set of classifications; and
performing the determination of the verification based on the set of classifications analysis, the analysis being a specific type of analysis that corresponds to a type of classifications in the set of classifications.

3. The method of claim 1, further comprising the set of classifications corresponding to a processing operation between the message item and the electronic message selected from a group consisting of: schema format analysis, threshold-based filtering, text pattern repetition, named entity recognition (NER), uniform resource locator (URL) analysis, pronoun analysis, number formatting, alphanumeric analysis, token overlap, cosine similarity, and entity presence analysis.

4. The method of claim 1, further comprising:
identifying the electronic message prior to delivery to the inbox; and
performing generation of the message item upon reception of the electronic message.

5. The method of claim 1, further comprising the extraction of the message information comprising:
extracting message information from the electronic message; and
extracting message information from the message item.

6. The method of claim 1, further comprising delivering the message item when the verification determination indicates the message item maps to the electronic message.

7. The method of claim 1, further comprising the message item being generated via application of a summarization computer model.

8. The method of claim 1, further comprising the message item being generated via application of a triaging model.

9. A system comprising:
a processor configured to:
identify a message item, the message item being a modified message item associated with an electronic message addressed to an inbox of a recipient;
extract message information, the extracted message information corresponding to the message item and the electronic message;
analyze, via a computer model, the extracted message information;
determine, based on the computer model analysis, a set of classifications that provide indications of a manner the message item maps to the electronic message;
determine, based on the set of classifications, a verification of the message item; and
control delivery of the message item to the inbox based on the verification determination.

10. The system of claim 9, wherein the processor is further configured to:
analyze the set of classifications; and
perform the determination of the verification based on the set of classifications analysis, the analysis being a specific type of analysis that corresponds to a type of classifications in the set of classifications.

11. The system of claim 9, further comprising the set of classifications corresponding to a processing operation between the message item and the electronic message selected from a group consisting of: schema format analysis, threshold-based filtering, text pattern repetition, named entity recognition (NER), uniform resource locator (URL) analysis, pronoun analysis, number formatting, alphanumeric analysis, token overlap, cosine similarity, and entity presence analysis.

12. The system of claim 9, wherein the processor is further configured to:
identify the electronic message prior to delivery to the inbox; and
perform generation of the message item upon reception of the electronic message.

13. The system of claim 9, wherein the processor is further configured to:
extract message information from the electronic message; and
extract message information from the message item.

14. The system of claim 9, wherein the processor is further configured to deliver the message item when the verification determination indicates the message item maps to the electronic message.

15. A non-transitory computer-readable storage medium tangibly encoded with computer-executable instructions that when executed by a processor, perform a method comprising:
identifying a message item, the message item being a modified message item associated with an electronic message addressed to an inbox of a recipient;
extracting message information, the extracted message information corresponding to the message item and the electronic message;
analyzing, via a computer model, the extracted message information;
determining, based on the computer model analysis, a set of classifications that provide indications of a manner the message item maps to the electronic message;
determining, based on the set of classifications, a verification of the message item; and
controlling delivery of the message item to the inbox based on the verification determination.

16. The non-transitory computer-readable storage medium of claim 15, further comprising:
analyzing the set of classifications; and
performing the determination of the verification based on the set of classifications analysis, the analysis being a specific type of analysis that corresponds to a type of classifications in the set of classifications.

17. The non-transitory computer-readable storage medium of claim 15, further comprising the set of classifications corresponding to a processing operation between the message item and the electronic message selected from a group consisting of: schema format analysis, threshold-based filtering, text pattern repetition, named entity recognition (NER), uniform resource locator (URL) analysis, pronoun analysis, number formatting, alphanumeric analysis, token overlap, cosine similarity, and entity presence analysis.

18. The non-transitory computer-readable storage medium of claim 15, further comprising:
identifying the electronic message prior to delivery to the inbox; and
performing generation of the message item upon reception of the electronic message.

19. The non-transitory computer-readable storage medium of claim 15, further comprising the extraction of the message information comprising:
extracting message information from the electronic message; and
extracting message information from the message item.

20. The non-transitory computer-readable storage medium of claim 15, further comprising delivering the message item when the verification determination indicates the message item maps to the electronic message.
